(19) United States
(12) Patent Application Publication
(10) Pub. No.: US 2009/0048929 A1
(43) Pub. Date: Feb. 19, 2009

(54) AUTHENTICATED TRAVEL RECORD

(76) Inventor: Paul Im, Scarsdale, NY (US)

Correspondence Address: Paul Im, 12 Parkway Circle, Scarsdale, NY, 10583, US

(21) Appl. No.: 12/192,099

(22) Filed: Aug. 14, 2008

Related U.S. Application Data
(60) Provisional application No. 60/956,125, filed on Aug. 15, 2007.

(51) Int. Cl. G06Q 30/00; G06F 7/04

(52) U.S. Cl. 705/14; 340/5.8; 340/5.82

(57) ABSTRACT

Users can maintain an authenticated travel record by using an authentication device at all the locations they've visited around the world. The authentication device can be a wireless router that provides WiFi Internet access to the user. Authentication information is sent to a travel database, and the user's profile is updated to reflect their presence at the location. The user's travel record can be accessed by the user or the public via the Internet. The user can be given advertisements and/or new location suggestions based on their current location. Advertising revenue can be shared between the travel database and the location.

### CROSS-REFERENCE TO RELATED APPLICATIONS

This non-provisional application claims the benefit of Provisional Application Ser. No. 60/956,125, filed Aug. 15, 2007, entitled WORLD TRAVELER, which is hereby incorporated herein by reference.

### FIELD OF THE INVENTION

This disclosure is directed to computer network applications and, more particularly, to methods and systems for creating, maintaining and providing an authenticated travel record.

### BACKGROUND OF THE INVENTION

Passport stamps provide a great authenticated record of all the places you traveled to, unfortunately passports expire and you have to start a new collection of stamps with your new booklet. In addition, passports are limited to recording only the airports you've visited. Furthermore, it is not possible to share your passport travels with a public audience.

Currently available travel Internet applications, such as, tripadvisor.com's “Cities I've Visited” application for facebook.com (“Cities I've Visited” was available at the time of filing the non-provisional application, but the applicant is not certain whether the program is prior art to the aforementioned co-pending provisional application), or a travel blog allow a user to provide a public record of all the places they've visited, but the information is not authenticated. A user can insert any country or city they desire whether or not they've actually been to that location.

GPS devices such as Trackstick can authenticate your presence at global locations and input that data into a map program such as Google Earth. However, the locations themselves do not know whether the user has visited their location. Thus, location specific information can't be transmitted to the user. In addition, the saved positions are just GPS coordinates. There is nothing connecting the coordinates to a location, which can be a city, a country, a tourist attraction, a restaurant, etc.

Accordingly, there is a desire for novel implementations of a travel record that can be authenticated, is available to the public and allows for location interaction with the user.

### SUMMARY OF THE INVENTION

The invention as described and claimed herein satisfies this and other needs, which will be apparent from the teachings herein.

In an embodiment, a method of keeping a travel record comprises, visiting a location, wherein the location has an authentication device, using the authentication device to authenticates a user's presence at the location, and maintaining a record of the locations that the user has visited, wherein the record is accessible to the user through a network connection.

In an embodiment, an authentication device comprises, a network connector, wherein the connector can transmit and receive information between a network and a travel record user, and an authenticating tool, wherein the tool can authenticates the user's presence at a location, and wherein the authenticating tool can transmit authentication information to a travel database coupled to the network.

In an embodiment, a method of advertising comprises receiving location information of a user being at a location, wherein the location is a participating member of a travel record service, retrieving an advertisement based on the location, and transmitting the advertisement to the user.

Other objects and features of the invention will become apparent from the following detailed description, considering in conjunction with the accompanying drawing figures. It is understood however, that the drawings are designed solely for the purpose of illustration and not as a definition of the limits of the invention.

### BRIEF DESCRIPTION OF THE DRAWING FIGURES

The drawing figures are not to scale, are merely illustrative, and like reference numerals depict like elements throughout the several views.

FIG. 1 illustrates a system implemented according to an embodiment of the invention.

FIG. 2 illustrates a method for updating a user's travel record implemented according to an embodiment of the invention.

FIG. 3 illustrates an authentication device embodied as a kiosk implemented according to an embodiment of the invention.

FIG. 4 illustrates a travel record implemented according to an embodiment of the invention.

### DETAILED DESCRIPTION OF EXEMPLARY EMBODIMENTS

There will now be shown and described in connection with the attached drawing figures several embodiments of a sidebar and methods for providing the same.

The term Internet as used herein, unless otherwise specified expressly or by context, is intended to have a broad non-limiting definition, and refers, without limitation, to a global computer network and/or any other group or subgroup of computers or other computing devices communicatively coupled together.

In an embodiment of the invention, a website or other database maintains an authenticated record of all the places a traveler has visited. In an embodiment, wireless Internet access can be provided at various locations such as major tourist attractions (e.g., the Empire State Building, Mount Rushmore, Golden Gate Bridge), notable restaurants (Spago, Nobu, The French Laundry, various Hard Rock Cafés), and famous shopping venues (Macy's Herald Square, The Mall of America), etc. Travelers visit an attraction and log onto the database/website using the wireless Internet access. The wireless router can contain a unique number for authentication. Other authentication methods can exist such as taking a picture by an official camera, finger printing, iris recognition, GPS tracking, etc. In an embodiment, some or all of the locations can comprise a kiosk or station. Travelers can use the kiosk to login and/or otherwise authenticate themselves. The kiosk can comprise the wireless router, so people can use their own device to authenticate themselves.

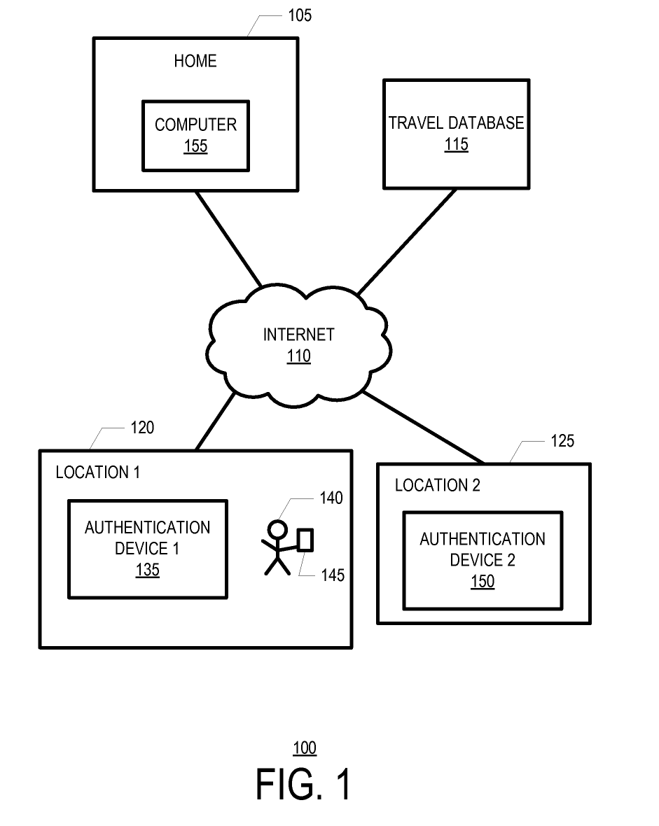

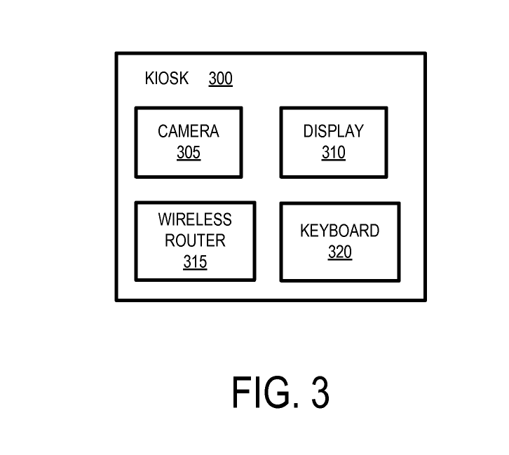

FIG. 1 illustrates a system 100 implemented according to an embodiment of the invention. System 100 comprises a user's home 105, a travel database 115, a first participation location 120, and a second participation location 125 each coupled to a computer network 110, e.g., the Internet. The home location 105 comprises a computer 155, which can be used to access a travel record from the travel database 115. Location one 120 comprises a first authentication device 135 and a traveler 140; the traveler has a mobile computing device 145, e.g., a smart phone. Location two 125 comprises a second authentication device 150. In embodiments of the invention, the authentication devices 135, 150, can be implemented as a wireless router, and or a kiosk as will be described below with reference to FIG. 3.

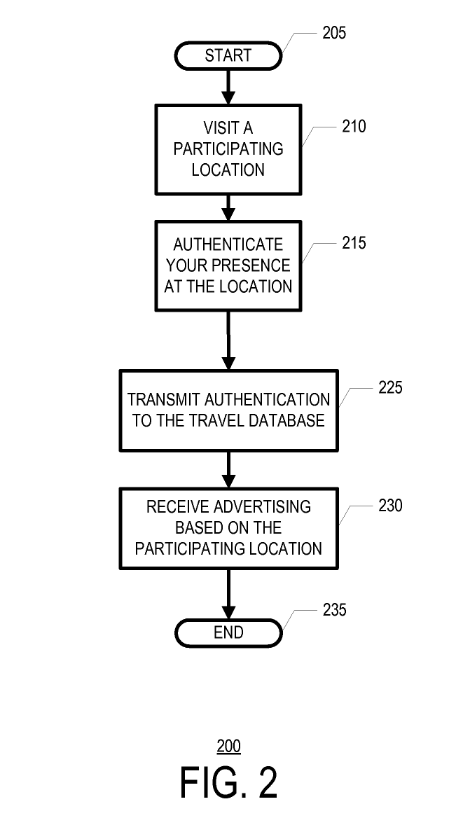

FIG. 2 illustrates a method 200 for updating a user's 140 travel record implemented according to an embodiment of the invention. Method 200 starts in step 205, and then proceeds to step 210, where a traveler 140 visits a participating location, e.g. location one 120. At location one 120, the method proceeds to step 215 where the traveler 140 authenticates his or her presence at the geographical location. In an embodiment, the authentication device one 135 is a wireless router with a unique identifier. The traveler can authenticate their presence at that location 120 by using their smart phone 145 via the wireless router 135 to communicate with the travel database 115, over the Internet 110. In step 225, the smart phone 145 and/or the wireless router 135 can transmit authentication information, such as, for example, the unique identifier, GPS coordinates, etc. to the travel database 115. Once the authentication information is received, the travel database 115 can update the traveler's 140 record to show the newly visited location. In an embodiment, the travel database 115 will allow the traveler 140 to upload a picture taken at the location as additional proof.

In another embodiment, the authentication device 135 can be a kiosk 300, as illustrated in FIG. 3. Kiosk 300 comprises a camera 305, a display 310, a wireless router 315 and a keyboard 320. Travelers without a mobile device can use the kiosk to log in with the travel database 115 and update their records.

Returning to method 200, in step 230, the traveler 140 receives advertising based on the participating location 120. For example, in one embodiment, location two 125, can be a restaurant located close to location one 120. An advertisement for location two 125 is sent to the traveler 140 because the traveler 140 is logging onto the travel database from a nearby location 120. Advertising can be transmitted by travel database 115, and/or by a third party provider. Method 200 ends in step 235. In an embodiment, a plurality of advertisements can be prioritized by the amount of revenue generated by the advertisement. In an embodiment, an advertisement associated with a location with a large number of visitors could get preferential or detrimental treatment.

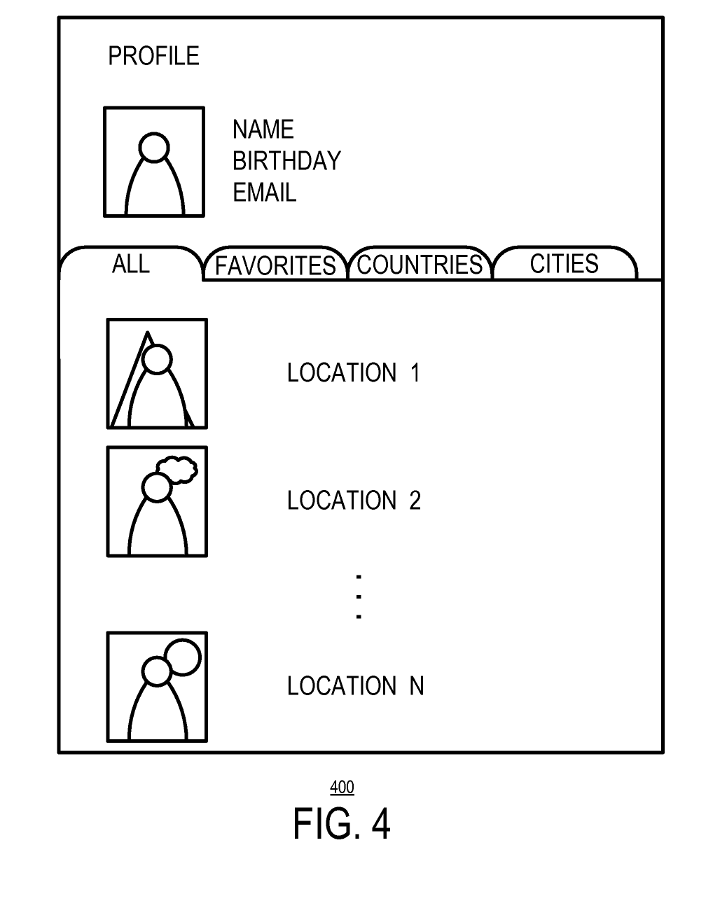

In an embodiment, the travel database can be displayed to users as a website. FIG. 4 illustrates a travel record 400 implemented according to an embodiment of the invention. The travel record comprises a user profile section comprising a picture of the user and some user information, such as, their name, birthday and email. The travel record 400 also comprises a listing of all the locations that the traveler has visited. In an embodiment, the travel record 400 can include user and/or website defined tabs that can be used to sort the different locations that the traveler has visited. For example, tabs can include a full listing, the user's favorite locations, just countries or just cities.

In an embodiment, the website/travel database can be part of a social networking site and users can see where their friends have been. Visitors can compare where they have been and can browse where other people have been. The website can also be tied to a person's photo album so you can browse additional pictures. The website can also comprise a blog or blog like feature, where the travelers and website visitors can make comments. The website can include a list of the top 50 world travelers. Celebrities could get involved. People may want to visit the places where celebrities visit. There can be a privacy mode, where people allow access to a limited number of visitors.

The site can record the date and time a traveler has been to a location. Locations can create their own personal graphics or “passport stamps” that will be awarded to the traveler. There can be a plurality of sorting options. The locations can be sorted into tiers by the amount of advertising it generates and/or by the number of travelers that have visited the location. You can sort by type of location. In an embodiment, advertising sent to a user can be prioritized based on the revenue the ad generates, the number of travelers that visit the location in the ad, and other by other means.

Any location or business can apply to be part of the travel network, such as amusement parks or shops. In an embodiment, the wireless access is funded by advertising, or more specifically, a location can receive part of the click through revenue for the clicks generated by the location. The website and/or the location can cover any additional cost not covered by the advertising. Profits can be split or given to one of the parties. Locations can be incentivized to install a router and or kiosk because they can make part of the advertising revenue. That money can be used to fund the location or it can be donated to charity. In other embodiments, the provider of the website can cover the costs, the location can pay, or there can be a monthly fee.

In an embodiment, a single site can have multiple sub locations, such as the bottom of the Empire State and the Top of the Empire state.

In an embodiment, visiting any location in a city qualifies you as having visited the city. A city can also create an official location, such as in Times Square.

Big marketing stunts can be made, such as placing a locator on the top of Mount Everest.

Advertisements can be for local restaurants and/or shops, one or more of which could be a location themselves.

It will be recognized that while the features and functions described above are described in relation to network components and user side components, such features and functions can be implemented at any point in the network, on single or multiple computers and/or servers, and network functions can also be duplicated at the user computer for functioning independent of the network if desired. Thus user side changes and or network side changes can be synchronized and or synchronized when a user returns to the network in manners known in the art or hereafter to become known.

While the description of the various embodiments of the invention are described in a server/client network environment, alternate embodiments of the invention can be performed in a peer-to-peer network or other interconnectivity schemes now known or hereafter to become known.

While there have been shown and described and pointed out fundamental novel features of the invention as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed:

1. A method of keeping a travel record comprising:
visiting a location, wherein the location has an authentication device;
using the authentication device to authenticates a user's presence at the location; and
maintaining a record of the locations that the user has visited, wherein the record is accessible to the user through a network connection.

2. The method of claim 1, wherein authenticating a user's presence comprises at least one of logging into a website through a specific router, taking a picture at a location, finger printing, iris recognition and transmitting GPS information.

3. The method of claim 1, wherein the user's record is made available for public viewing on the internet.

4. The method of claim 3, wherein visitors to the user's record can make comments regarding a location visited by the user.

5. The method of claim 3, wherein the user's record can be publicly available to a selective group of people.

6. The method of claim 1, wherein the travel record is displayed as part of a social networking site.

7. The method of claim 1, wherein the travel record is coupled with a photo album.

8. The method of claim 1, wherein the location can have a plurality of sub locations.

9. An authentication device, the device comprising:
a network connector, wherein the connector can transmit and receive information between a network and a travel record user; and
an authenticating tool, wherein the tool can authenticates the user's presence at a location, and wherein the authenticating tool can transmit authentication information to a travel database coupled to the network.

10. The device of claim 9, wherein the authenticating tool is at least one of a module for logging into a website, a camera, a fingerprint capture device, an iris recognition device and a GPS receiver.

11. The device of claim 9, wherein the device is a wireless router.

12. The device of claim 9, wherein the device is part of a stand-alone kiosk.

13. A method of advertising comprising:
receiving location information of a user being at a location, wherein the location is a participating member of a travel record service;
retrieving an advertisement based on the location; and
transmitting the advertisement to the user.

14. The method of claim 13, wherein the advertisement is for an establishment in close proximity to the location.

15. The method of claim 13, wherein the advertisement comprises a coupon for use at a location.

16. The method of claim 13, wherein the advertisement is for another participating location.

17. The method of claim 16, wherein advertisement revenue is collected from an advertised location if the user adds the advertised location to their record.

18. The method of claim 13, wherein the participating location receives at least some part of the advertising revenue generated from their location.

19. The method of claim 13, further comprising selecting an advertisement to send to the user based on the past revenue generated by the ad.

20. The method of claim 13, further comprising selecting an advertisement based on the number of visitors a location associated with the advertisement has in the travel record service.
